(19) United States
(12) Patent Application Publication
(10) Pub. No.: US 2010/0191570 A1
(43) Pub. Date: Jul. 29, 2010

(54) LOYALTY REWARD PROGRAM SIMULATORS

(76) Inventors: Joe Phillip Michaud, St. Louis, MO (US); David Russell Adams, St. Louis, MO (US); Jennifer Lynn Kallery, O'Fallon, MO (US); Keith Chrzan, Chesterton, IN (US)

Correspondence Address: SENNIGER POWERS LLP, 100 NORTH BROADWAY, 17TH FLOOR, ST LOUIS, MO, 63102, US

(21) Appl. No.: 12/358,719

(22) Filed: Jan. 23, 2009

(51) Int. Cl. G06Q 30/00

(52) U.S. Cl. 705/10; 705/14.13; 705/14.27

(57) ABSTRACT

A method of defining an earnings profile and a reward profile for loyalty reward program for a credit card issuer for a plurality of participants. A survey to gather data related to the loyalty reward program earning types and the loyalty reward types is defined and response data related to the survey is collected from the plurality of participants. One or more segments of participants are identified as a function of the collected data. The collected data is further analyzed to determine the reach, frequency, and overlap of the loyalty reward program earning types for the identified segments and to determine preference shares for participants within the segments. At least one of the defined loyalty reward program earning types of the loyalty reward program is selected for the earnings profile of the loyalty reward program based on the determined reach, frequency, and overlap of the loyalty reward program earning types viewed in a first user interface. At least one of the defined loyalty reward types is for the reward profile of the loyalty reward program selected based on the determined choice for identified segments viewed in a second user interface.

### BACKGROUND

Retention of customers is an important goal for successful companies. The existence of a loyalty reward program may encourage a customer to do business with a company and attitudes towards rewards programs are generally positive. In a recent survey, about half of respondents believed that loyalty rewards programs make them more loyal to certain companies and forty-five percent are heavily influenced to use one credit card over another because of the credit card issuer's rewards program.

However, it can be difficult to determine the loyalty reward program earning type preferences and the loyalty reward type preferences that are desired by customers. And, loyalty program design and performance may be increased through modeling of customer loyalty reward program earning type preferences and the loyalty reward type preferences.

### SUMMARY

Embodiments of the invention include methods and systems for defining an earnings profile and a reward profile for loyalty reward program for a credit card issuer. In one embodiment, a survey to gather data related to the loyalty reward program earning types and the loyalty reward types is defined and response data related to the survey is collected from the plurality of participants. One or more segments of participants are identified as a function of the collected data. The collected data is further analyzed to determine the reach, frequency, and overlap of the loyalty reward program earning types for the identified segments and to determine preference shares are for participants within the segments. At least one of the defined loyalty reward program earning types of the loyalty reward program is selected for the earnings profile of the loyalty reward program based on the determined reach, frequency, and overlap of the loyalty reward program earning types viewed in a first user interface. And, at least one of the defined loyalty reward types is selected for the reward profile of the loyalty reward program based on the determined choice for identified segments viewed in a second user interface.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary flow diagram for a method of defining an earnings profile for loyalty reward program for a plurality of participants according to one embodiment of the invention.

FIG. 2 is an exemplary screen shot of the user interface used for testing the reach, frequency and overlap of potential segments according to one embodiment of the invention.

FIG. 3 is an exemplary flow diagram for a method of defining a reward profile for loyalty reward program for a plurality of participants according to one embodiment of the invention.

FIG. 4 is an exemplary screen shot of the user interface used to determine the choices for by a given participant segment for a particular set of loyalty reward type.

FIG. 5 is an exemplary flow diagram for a method of defining an earnings profile and a reward profile for loyalty reward program for a credit card issuer for a plurality of participants according to embodiments of the invention.

FIG. 6 is block diagram for an exemplary computerized system for defining an earnings profile and a reward profile for loyalty reward program for a credit card issuer for a plurality of participants according to one embodiment of the invention.

Corresponding reference characters indicate corresponding parts throughout the drawings.

### DETAILED DESCRIPTION

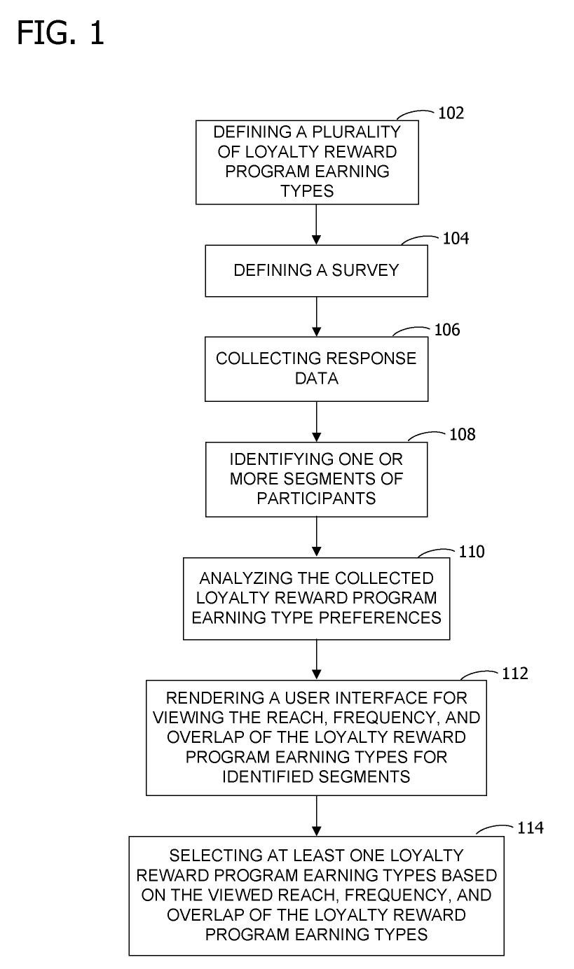

FIG. 1 is an exemplary flow diagram for a method of defining an earnings profile for loyalty reward program for a plurality of participants. In an embodiment, the loyalty reward program is associated with a credit card issuer. The earnings profile specifies an earning preference of a plurality of participants in a loyalty reward program. In an embodiment, a program owner (e.g., a credit card issuer) develops the loyalty reward program to allow customer to earn points (e.g., by using credit cards issued by the program owner). The points may then be used to receive a reward. For example, a company (as a program owner) may wish to develop loyalty reward program to encourage its customers (as participants) to use a credit card by providing points for certain transactions (e.g., bonus points for purchases at selected merchants). In turn, the customer may use the points to obtain a reward (e.g., a gift card for a selected retailer).

At 102, a plurality of loyalty reward program earning types 620 are defined. In an embodiment, the defined loyalty reward program earning types 620 include one or more of the following: Bonus points for every $100 spent, bonus points for purchases at selected merchants; discounts on selected purchases, accelerated point earning opportunities at specified ‘points earned’ levels, added benefits or special services at specified ‘points earned’ levels, special benefits or upgrades, earning points for suggesting ideas to loyalty reward program owner, bonus points at specified ‘points earned’ levels, special point of sale/purchase offers customized for each of the plurality of participants, bonus points for redeeming promotional merchandise, and earning points for visiting the rewards program website.

At 104, a survey 622 is defined for gathering data related to the defined loyalty reward program earning types 620 of the plurality of participants. In an embodiment, the survey 622 includes Q-sort formatted questions for gathering data related to the defined loyalty reward program earning types 620. In another embodiment, the survey 622 includes one or more of the following: loyalty reward program knowledge questions, loyalty reward program usage questions, loyalty reward program attitudinal questions, communication preference questions, and demographic questions. An exemplary survey template developed in accordance to aspects of the invention is shown in Appendix A.

At 106, response data 624 is collected from the plurality of participants related to the defined survey 622. The response data 624 includes loyalty reward program earning type preferences. At 108, one or more segments of participants are identified as a function of the collected data. Each identified segment of participants includes participants associated with a subset of the loyalty reward program earning types 620. Each of the identified segments of participants include similar loyalty reward program earning type preferences. In an embodiment, cluster analysis is conducted on the collected loyalty reward program earning type preferences to identify the segments of participants.

At 110, the collected loyalty reward program earning type preferences are analyzed to determine a reach, frequency, and overlap of the loyalty reward program earning types 620 for the identified segments. In an embodiment, TURF (Total Unduplicated Reach & Frequency) analysis is conducted on the collected loyalty reward program earning type preferences to determine the reach, frequency, and overlap of the loyalty reward program earning types 620 for the identified segments. The TURF analysis calculates optimal configurations for the earnings profile to maximizing reach. Reach or coverage is defined as the proportion of the participants that choose a particular combination of one or more of the loyalty reward program earning types 620 (e.g., bonus points for redeeming promotional merchandise, special benefits of upgrades).

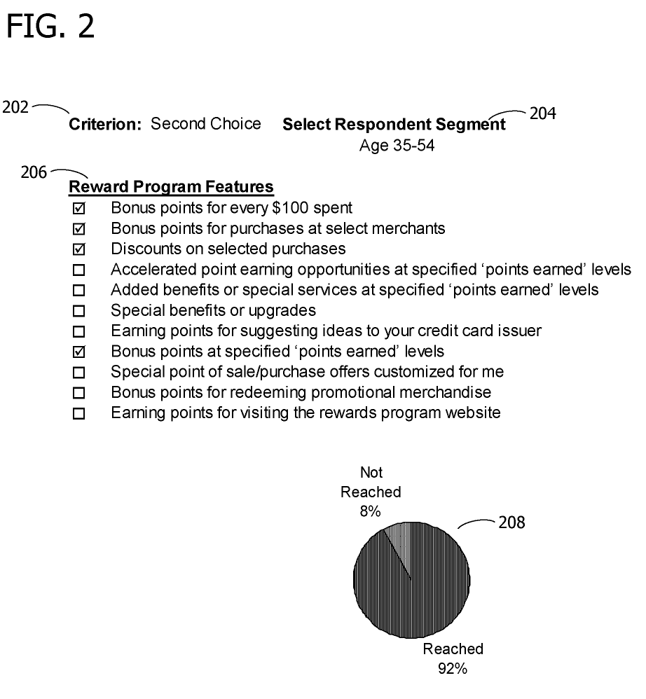

At 112, a user interface is rendered indicating the determined reach, frequency, and overlap of the loyalty reward program earning types 620 for the identified segments based on the analyzed loyalty reward program earning type preferences. FIG. 2 is an exemplary screen shot of the user interface used for testing the reach, frequency and overlap of potential segments. An operator of the user interface may change the criterion 202 or identified segment 204 by clicking on the area surrounding the criterion 202 or identified segment 204, respectively. A drop down box will appear from which the operator may select a choice for the criterion 202 or identified segment 204.

Additionally, the operator may choose to include or exclude loyalty reward program earning types 620 using the check boxes to the left of the Reward Program Features 206 list. Selected loyalty reward program earning types 620 will be included in the loyalty program to be evaluated. The results 208 are updated automatically in response to operator input. In an embodiment, the criterion 202 ranges from first choice to fifth choice, which are the loyalty reward program earning types 620 the participants were asked about in the survey. The level the criterion 202 is set to define the minimum choice category to be included. For example, if you select ‘Second Choice’ the results 208 would include any chosen feature (e.g., loyalty reward program earning types 620) that a participant rated as their first or second choice. Results 208 are shown are in the pie chart as the percent of participants that selected at least one of the loyalty reward program earning types 620 of the program at the level of the criterion 202 or higher. For example, for the results 208 shown in FIG. 2, 92% of the participants aged 35-54 selected the checked loyalty reward program earning types 620 (e.g., discounts on selected purchases) as their first or second choice.

Referring again to FIG. 1, at 114, at least one of the defined loyalty reward program earning types 620 is selected based on the determined reach, frequency, and overlap of the loyalty reward program earning types 620 for identified segments for the earnings profile of the loyalty reward program. For example, the program owner may select loyalty reward program earning types 620 that maximizes the reach for all participants or that maximizes the reach for a particular segment, (e.g., participants who are college graduates). Other factors, such as implementation costs, may be considered by the program owner when selecting the defined loyalty reward program earning types 620 for the earnings profile of the loyalty reward program. Advantageously, through utilization of the user interface, the program owner can view loyalty reward program earning types 620 that target specific segments of customers (e.g., participants aged 35-54) or view loyalty reward program earning types 620 that target the majority of customers.

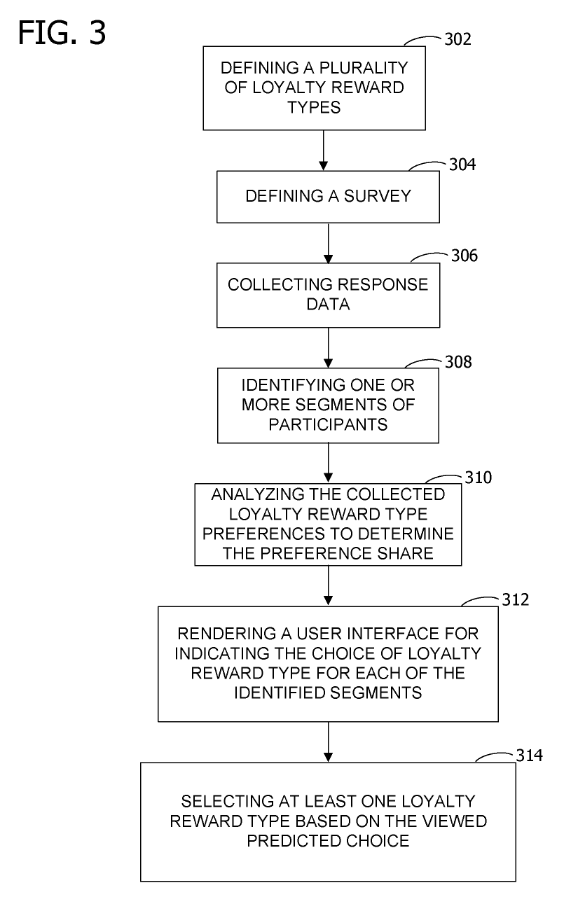

FIG. 3 is an exemplary flow diagram for a method of defining a reward profile for loyalty reward program for a plurality of participants. In an embodiment, the loyalty reward program is associated with the credit card issuer. At 302, a plurality of loyalty reward types 618 of the loyalty reward program are defined. In an embodiment, the defined loyalty reward types 618 include one or more of the following: Electronics, house wares, luggage, travel, gift cards, and cash.

At 304, a survey 622 is defined to gather data related to the defined loyalty reward types 618 of the plurality of participants. In embodiment, the survey 622 includes one or more of the following: loyalty reward program knowledge questions, loyalty reward program usage questions, loyalty reward program attitudinal questions, communication preference questions, and demographic questions.

In another embodiment, Q-sort formatted questions for gathering data related to the defined loyalty reward types 618 are defined. Q-sort is a method of scaling responses in survey research. Q-sort forces participants to rank the items (e.g., defined loyalty reward types 618 ) to conform to a quasi-normal distribution. Advantageously, Q-sort requires only a very small number of items to receive the highest rating and the lowest rating. Q-sort requires larger, but still small, numbers of items to receive the next highest and next lowest rating. By forcing the participants to rate most items in a middle category, the resulting distribution of ratings follows the familiar bell-shaped normal curve. For example, for a Q-sort rating of 15 items, the distribution into 5 groups, lowest to highest might be: 1:3:7:3:1.

At 306, response data 624 is collected from the plurality of participants related to the defined survey 622. The response data 624 includes loyalty reward type preferences. At 308, one or more segments of participants are identified as a function of the collected data. Each identified segment of participants includes participants associated with a subset of the loyalty reward types 618. And, each identified segment of participants includes similar loyalty reward type preferences. In an embodiment, cluster analysis is conducted on the collected loyalty reward type preferences to identify the segments of participants.

At 310, the collected loyalty reward type preferences are analyzed to determine a preference share for each of the plurality of participants for each of the plurality of loyalty reward types 618. In an embodiment, the collected loyalty reward type preferences are modeled utilizing multinomial logit to produce utilities, although other modeling such as Bayesian multinomial logit may be used. Next, the produced utilities are scaling to determine the preference shares of each of the plurality of participants.

For example, in an embodiment, the core of the discrete choice modeling is a set of 12 choice questions that look like this:

You have 15,000 points. Which of the following rewards would you select?
a) $100 Cash requiring 8,000 points
b) $100 Travel Voucher requiring 14,000 points
c) $100 Store Gift Card requiring 8,000 points
d) 1 GB Music Player requiring 10,000 points
e) 10-Pc. Cookware Set requiring 6,000 points
f) Premium Bag Expandable 2-Pc. Luggage Set requiring 12,000 points
g) None of these. Keep my 15,000 points for another reward.

The exact mix of attribute levels varies from one choice question to the next according to an experimental design. In this embodiment, each of the participants was randomly assigned to one of three price-point categories—10,000, 20,000 or 40,000 points—and was presented with three rewards from each of the following loyalty reward types 618: electronics, house wares, luggage, and gift cards. After reviewing each of the rewards, respondents were asked to select the one reward they would be most likely to choose. All participants were then presented with 12 sets of 6 reward configurations for consideration. After reviewing each set of configurations, participants were asked to choose the one reward they found most appealing.

Each of the 12 reward configurations included cash, a travel voucher, and one reward from each of the loyalty reward types 618 detailed above. The items presented for each loyalty reward types 618 were those that the participant selected in the first part of this task. Participants were also given the option to choose none of the rewards and keep accumulating points instead. Advantageously, the separate effects of loyalty reward types 618, prices, other attributes and even unique price curves or attribute utilities per loyalty reward types 618, can be extracted during statistical analysis.

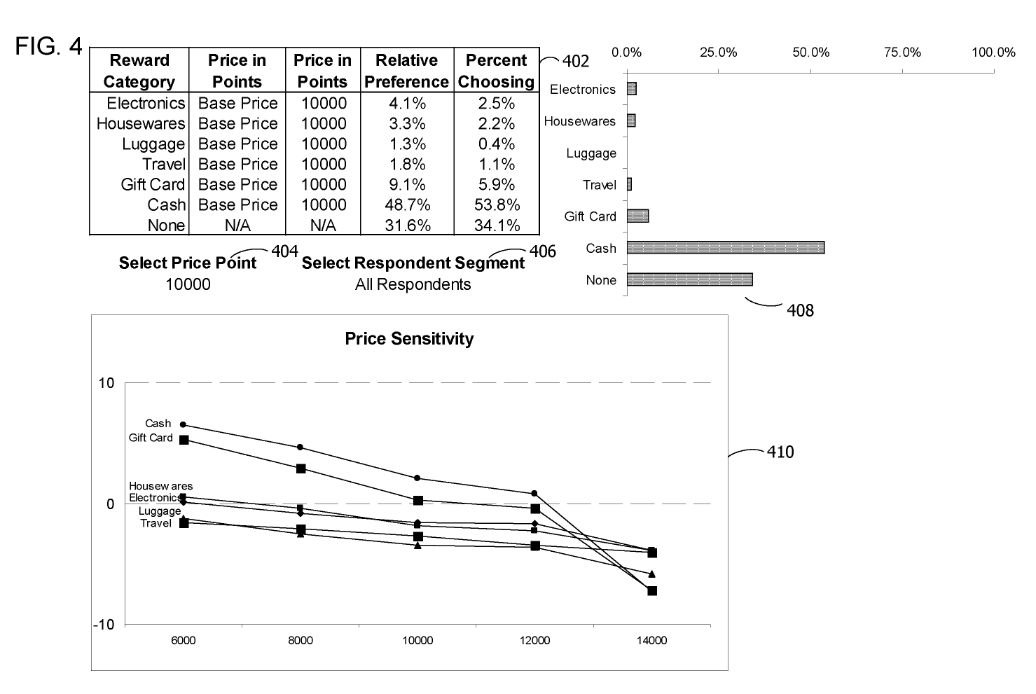

At 312, a user interface is rendered indicating a choice of loyalty reward type 618 for the identified segments based on the determined preference shares of the participants within the segment. FIG. 4 is an exemplary screen shot of the user interface used to determine the choices for by a given participant segment for a particular set of loyalty reward type 618. The price cells in the table 402 for each loyalty reward type 618 may be changed to test different rewards programs against one another. The ability to include or exclude a loyalty reward type 618 is also included.

Results are shown in the table 402 by the Relative Preference and Percent Choosing metrics. The Relative Preference assumes that each participant makes choices based on his/her relative preferences, so if the participant prefer one loyalty reward type 618 to another by 2:1, then the first loyalty reward type 618 will be chosen 67% of the time and the other 33%. The Percentage Choosing uses the winner takes all method, so the most preferred loyalty reward type 618 wins every close call. The user interface allows changes to the price point 404 (e.g., 10,000, 20,000, or 40,000 points) and/or the participant segments 406 (e.g., all respondents). Additionally, a bar graph 408 representing the Percent Choosing metric and a price sensitivity curve 410 are also included within the user interface.

A utility of less than zero for a particular loyalty reward type 618 in the price sensitivity curve indicates that the participant would prefer to keep their points over receiving that reward. For example, the price sensitivity curve 410 shown in FIG. 4 indicates that at the 10,000 point level, all participants would prefer to keep their points instead of receiving an electronics, a house wares, a luggage or travel reward and at the 14,000 point level, all participants would prefer to keep their points instead of receiving any reward (all utilities are below zero).

Referring again to FIG. 3, at 314, at least one of the defined loyalty reward types 618 is selected based on the viewed determined choices for identified segments for the reward profile of the loyalty reward program. For example, the program owner may select loyalty reward types 618 with the greatest relative preference for all participants (e.g., 48.7% preference for a cash reward) or that maximizes the greatest relative preference for a particular segment, (e.g., participants who are college graduates). Other factors, such as implementation costs, may be considered by the program owner when selecting the defined loyalty reward types 618 for the reward profile of the loyalty reward program. Advantageously, through utilization of the user interface, the program owner can view loyalty reward types 618 at particular point levels that target specific segments of customers (e.g., participants with an income between $60,000 and 80,000) or view loyalty reward types 618 that target all customers.

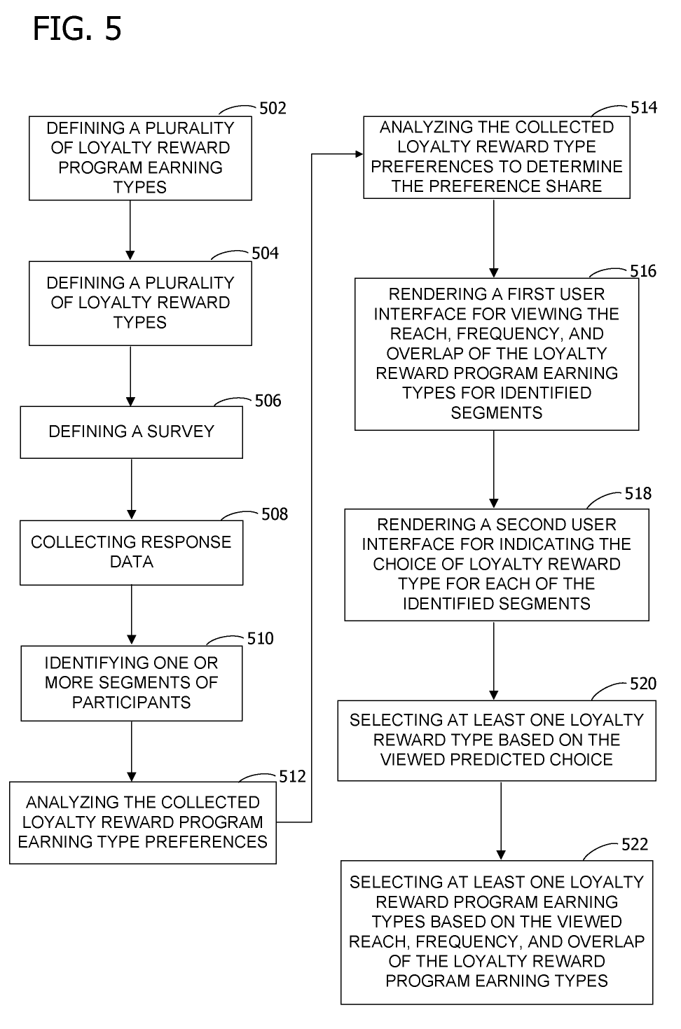

FIG. 5 is an exemplary flow diagram for a method of defining an earnings profile and a reward profile for loyalty reward program for a credit card issuer for a plurality of participants. At 502, a plurality of loyalty reward program earning types 620 are defined. And, at 504, a plurality of loyalty reward types 618 of the loyalty reward program are defined.

At 506, a survey 622 is defined to gather data related to the defined loyalty reward program earning types 620 and the defined loyalty reward types 618 of the plurality of participants. In an embodiment, the survey 622 includes one or more of the following: loyalty reward program knowledge questions, loyalty reward program usage questions, loyalty reward program attitudinal questions, communication preference questions, and demographic questions.

In another embodiment, the survey 622 includes Q-sort formatted questions for gathering data related to the defined loyalty reward program earning types 620 and discrete choice modeling questions to determine price sensitivity for each loyalty reward type 618. Exemplary survey questions used for gathering data related to the defined loyalty reward program earning types 620 are included in Module 3 of the survey template shown in Appendix A. And, exemplary survey questions used for gathering data related to the defined loyalty reward types 618 are included in Module 4 of the survey template shown in Appendix A.

At 508, response data 624 is collected from the plurality of participants related to the survey 622. The response data 624 including loyalty reward program earning type preferences and loyalty reward type preferences. At 510, one or more segments of participants are identified as a function of the collected data. For example, collected response data 624 for the demographic questions of the survey 622 are used to determine the segments. Exemplary demographic questions are included in Module 6 of the survey template shown in Appendix A.

Each identified segment of participants includes participants associated with the subset of the loyalty reward program earning types 620 or a subset of the loyalty reward types 618. And, each identified segment of participants includes a similar loyalty reward program earning types preferences or each identified segment of participants includes similar loyalty reward type preferences. In an embodiment, cluster analysis is conducted on the collected response data 624 to identify the segments of participants. For example, collected response data 624 for the loyalty reward program knowledge questions, loyalty reward program usage questions, and loyalty reward program attitudinal questions of the survey 622 are analyzed using cluster analysis. Exemplary loyalty reward program knowledge questions and loyalty reward program usage questions are included in Module 1 of the survey template shown in Appendix A. Exemplary loyalty reward program attitudinal questions are included in Module 2 of the survey template shown in Appendix A.

At 512, the collected loyalty reward program earning type preferences are analyzed to determine a reach, frequency, and overlap of the loyalty reward program earning types 620 for the identified segments. In an embodiment, TURF (Total Unduplicated Reach & Frequency) analysis is conducted on the collected loyalty reward program earning type preferences to determine the reach, frequency, and overlap of the loyalty reward program earning types 620 for the identified segments.

At 514, the collected loyalty reward type preferences are analyzed to determine a preference share for each of the plurality of participants for each of the plurality of loyalty reward types 618. In an embodiment, the collected loyalty reward type preferences are modeled utilizing multinomial logit to produce utilities, although other modeling such as Bayesian multinomial logit may be used. Next, the produced utilities are scaled to determine the preference shares of each of the plurality of participants. In an embodiment, cluster analysis is conducted on the collected response data 624 to identify the segments of participants.

At 516, a first user interface indicating the determined reach, frequency, and overlap of the loyalty reward program earning types 620 for the identified segments based on the analyzed loyalty reward program earning type preferences is rendered. As explained above, FIG. 2 is an exemplary screen shot of the first user interface used for testing the reach, frequency and overlap of potential segments.

At 518, a second user interface indicating a choice of loyalty reward type 618 for the identified segments based on the determined preference shares of the participants within the segment is rendered. As explained above, FIG. 4 is an exemplary screen shot of the second user interface used for interface used to determine the choices for by a given participant segment for a particular set of loyalty reward type 618.

At 520, at least one of the defined loyalty reward program earning types 620 is selected based on the determined reach, frequency, and overlap of the loyalty reward program earning types 620 for identified segments for the earnings profile of the loyalty reward program. And, at 522, at least one of the defined loyalty reward types 618 is selected based on the viewed determined choice for identified segments for the reward profile of the loyalty reward program.

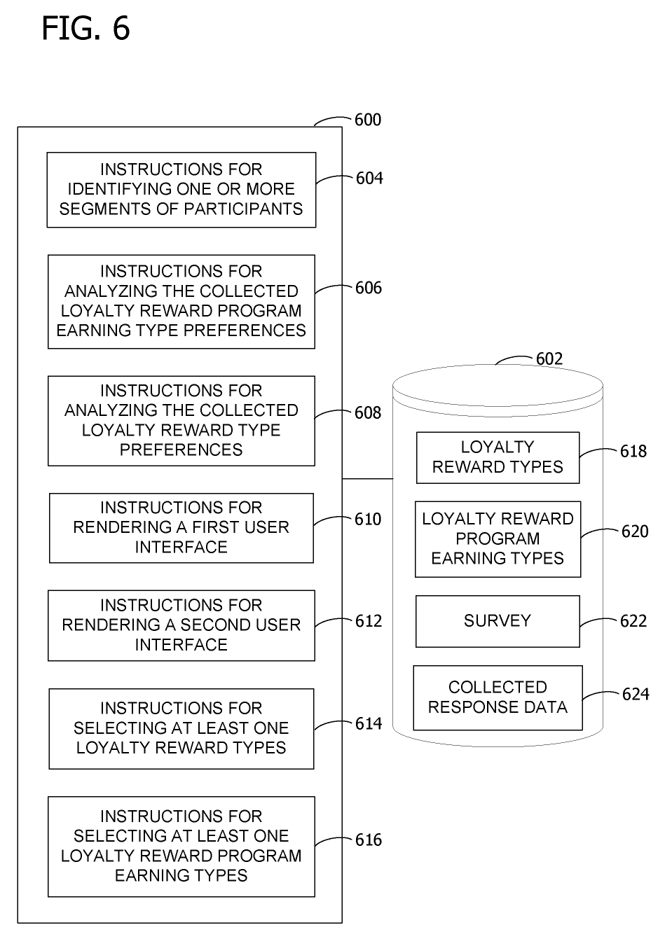

FIG. 6 is block diagram for an exemplary computerized system including a computer 600 and data storage 602 for defining an earnings profile and a reward profile for loyalty reward program for a credit card issuer for a plurality of participants. The computer 600 may access the data storage 602.

The data storage includes a plurality of loyalty reward program earning types 620, a plurality of loyalty reward types 618 of the loyalty reward program, a survey 622 to gather data related to the defined loyalty reward program earning types 620 and the defined loyalty reward types 618 of the plurality of participants, and response data 624 collected from the plurality of participants related to the survey 622. The response data 624 includes loyalty reward program earning type preferences and loyalty reward type preferences.

The computer 600 includes computer executable instructions stored on a computer readable media associated with the computer 600. The computer executable instructions include instructions for identifying one or more segments of participants 604 as a function of the collected data. Each identified segment of participants includes participants associated with a subset of the loyalty reward program earning types 620 or a subset of the loyalty reward types 618. And, each identified segment of participants includes a similar loyalty reward program earning type preferences or each identified segment of participants includes similar loyalty reward type preferences.

In an embodiment, cluster analysis cluster analysis is conducted on the collected data to identify the segments of participants. Cluster analysis is a mathematical method for categorizing objects (e.g., participants) into segments where the members of segments are more similar to one another than they are to members of other segments. And, the participants are segmented by their rated responses to each of the reward types. Cluster analysis involves repetition of one or more clustering algorithms (e.g., convergent K-means cluster analysis) to identify robust solutions followed by analysis of various fit statistics plus detailed investigation of the managerial usefulness of the segments.

The computer executable instruction further include instructions for analyzing the collected loyalty reward program earning type preferences 606 to determine the reach, frequency, and overlap of the loyalty reward program earning types 620 for the identified segments.

The computer executable instruction further include instructions for analyzing the collected loyalty reward type preferences 608 to determine the preference share for each of the plurality of participants for each of the plurality of loyalty reward types 618.

The computer executable instruction further include instructions for rendering a first user interface 610 indicating the reach, frequency, and overlap of the loyalty reward program earning types 620 for the identified segments based on the analyzed loyalty reward program earning type preferences.

The computer executable instruction further include instructions for rendering a second user interface 612 indicating the choice of loyalty reward type 618 for the identified segments based on the determined preference shares of the participants within the segment.

The computer executable instruction further include instructions for selecting at least one loyalty reward program earning type 614 based on the viewed reach, frequency, and overlap of the loyalty reward program earning types 620 for identified segments for the earnings profile of the loyalty reward program.

The computer executable instruction further include instructions for selecting at least one loyalty reward type 616 based on the viewed determined choice for identified segments for the reward profile of the loyalty reward program.

FIG. 6 shows one example of a general purpose computing device in the form of a computer 600. In one embodiment of the invention, a computer such as the computer 600 is suitable for use in the other figures illustrated and described herein. Computer 600 has one or more processors or processing units and a system memory

The computer 600 typically has at least some form of computer readable media. Computer readable media, which include both volatile and nonvolatile media, removable and non-removable media, may be any available medium that may be accessed by computer 600. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 600. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The computer 600 may also include other removable/non-removable, volatile/nonvolatile computer storage media. The drives or other mass storage devices and their associated computer storage media (e.g., data storage 602) provide storage of computer readable instructions, data structures, program modules and other data for the computer 600.

Generally, the data processors of computer 600 are programmed by means of instructions stored at different times in the various computer-readable storage media of the computer. At execution, they are loaded at least partially into the computer's primary electronic memory.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 600, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computer 600 executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

Below is a survey template according to aspects of the invention.

### [Introduction]

In this survey, we'd like to get your opinion about bank credit cards and the special programs they may offer. Your individual answers are confidential and will not be disclosed to anyone. We assure you that you will not be re-contacted as a result of participation on this survey. Thank you very much for participating.

### [Page Break]

We value your opinions and appreciate your participation in this survey.

Please give your full attention to this survey. Should our quality checks determine that you have not provided thoughtful attention to this survey, you may be disqualified and forfeit the associated rewards.

[SA] I will read each question thoroughly and I will respond to all questions thoughtfully and honestly.

| | | |
|---|---|---|
| I agree | [1] | [Continue] |
| I disagree | [2] | [Terminate] |

### [Page Break]

### [SCREENER]

[S1] Are you at least 18 years of age?

| | | |
|---|---|---|
| Yes | [1] | [Continue] |
| No | [2] | [Terminate] |

### [Page Break]

[S2] Are you . . .

| | |
|---|---|
| Male | [1] |
| Female | [2] |

### [Page Break]

[S3] Do you or does anyone in your immediate family work for . . .

| | | |
|---|---|---|
| A market research firm | [1] | [Terminate] |
| A credit card or charge card | [2] | [Terminate] |
| company | | |
| None of the Above | [3] | [Continue] |

### [Page Break]

### [MODULE 1—Program Knowledge and Usage]

The following questions will ask you about your participation in “rewards programs.” A rewards program is a program that a company runs which awards its customers “points” for purchases or other behaviors. These “points” can later be redeemed for various rewards including cash back, discounts, gift certificates, special offers, merchandise, or travel.

### [Page Break]

[Q 1.1] Please select the answer that most accurately reflects the number of rewards programs you are enrolled in, for each category.

### [PN: RANDOMIZE A-H.]

| | | | | | | | | |
|---|---|---|---|---|---|---|---|---|
| [a] | Restaurants | 0 | 1 | 2 | 3 | 4 | 5 | More Than 5 |
| [b] | Retail Stores | 0 | 1 | 2 | 3 | 4 | 5 | More Than 5 |
| [c] | Hotels | 0 | 1 | 2 | 3 | 4 | 5 | More Than 5 |
| [d] | Airlines | 0 | 1 | 2 | 3 | 4 | 5 | More Than 5 |
| [e] | Car Rental | 0 | 1 | 2 | 3 | 4 | 5 | More Than 5 |
| [f] | Bank Credit Cards | 0 | 1 | 2 | 3 | 4 | 5 | More Than 5 |
| [g] | Debit Cards | 0 | 1 | 2 | 3 | 4 | 5 | More Than 5 |
| [h] | Store Credit Cards | 0 | 1 | 2 | 3 | 4 | 5 | More Than 5 |

[PN: If Q1.1f=0, terminate]

### [Page Break]

[PN: Show table that includes rows from Q1.1̂>0. For each row, eliminate or ghost column choices greater than number chosen in Q1.1. SHOW IN SAME ORDER AS IN Q1.1.]

[Q1.2] Of those in which you are enrolled, how many would you say you participate in?

| | | | | | | | | |
|---|---|---|---|---|---|---|---|---|
| [a] | Restaurants | 0 | 1 | 2 | 3 | 4 | 5 | More Than 5 |
| [b] | Retail Stores | 0 | 1 | 2 | 3 | 4 | 5 | More Than 5 |
| [c] | Hotels | 0 | 1 | 2 | 3 | 4 | 5 | More Than 5 |
| [d] | Airlines | 0 | 1 | 2 | 3 | 4 | 5 | More Than 5 |
| [e] | Car Rental | 0 | 1 | 2 | 3 | 4 | 5 | More Than 5 |
| [f] | Bank Credit Cards | 0 | 1 | 2 | 3 | 4 | 5 | More Than 5 |
| [g] | Debit Cards | 0 | 1 | 2 | 3 | 4 | 5 | More Than 5 |
| [h] | Store Credit Cards | 0 | 1 | 2 | 3 | 4 | 5 | More Than 5 |

[PN: If Q1.2f=0, terminate]

[PN: Page Break]

[PN: Transition Statement] The next questions are about your credit card usage.

[Q1.3] When you pay your primary credit card bill, do you usually pay . . .

Please select one

| | |
|---|---|
| The minimum amount due | [1] |
| More than the minimum, but less than the | [2] |
| total amount due, or | |
| The entire balance | [3] |

### [Page Break]

[Q1.4a] Which one specific card do you use most often when making purchases?

Please select one

| | | |
|---|---|---|
| Debit Card | [1] | [Continue] |
| Credit Card | [2] | [Skip to Q1.4d] |

### [Page Break]

[Q1.4b] The debit card you use most for purchases is a:

Please select one

| | | |
|---|---|---|
| Credit Card 1 | [1] | |
| Credit Card 2 | [2] | |
| Credit Card 3 | [3] | |
| Other | [6] | |
| Don't Know | [8] | [Skip to Q1.5] |

### [Page Break]

[Q1.4c] Which one of the following institutions issued the [PN: IF Q14.B=1, 2, OR 3, INSERT RESPONSE FROM Q1.4B HERE] debit card you use most for purchases?

Please select one

| | |
|---|---|
| Bank 1 | [1] |
| Bank 2 | [2] |
| Bank 3 | [3] |
| Bank 4 | [4] |
| Bank 5 | [5] |
| Bank 6 | [6] |
| Bank 7 | [7] |
| Bank 8 | [8] |
| Bank 9 | [9] |
| Bank 10 | [10] |
| Credit Union | [11] |
| Local or Regional Bank | [12] |
| Other | [13] |

### [PN: SKIP TO Q1.4g]

[Page Break]

The credit card you use most for purchases is a:

Please select one

| | | |
|---|---|---|
| Credit Card 1 | [1] | [Continue] |
| Credit Card 2 | [2] | [Continue] |
| Credit Card 3 | [3] | [Skip to Q1.4f] |
| Credit Card 4 | [4] | [Skip to Q1.4f] |
| Other | [6] | [Skip to Q1.4f] |
| Don't Know | [8] | [Skip to Q1.5] |

### [Page Break]

[Q1.4e] Which one of the following institutions issued the [PN: INSERT RESPONSE FROM Q1.4D HERE] credit card you use most for purchases?

Please select one

| | |
|---|---|
| Bank 1 | [1] |
| Bank 2 | [2] |
| Bank 3 | [3] |
| Bank 4 | [4] |
| Bank 5 | [5] |
| Bank 6 | [6] |
| Bank 7 | [7] |
| Bank 8 | [8] |
| Bank 9 | [9] |
| Bank 10 | [10] |
| Credit Union | [11] |
| Local or Regional Bank | [12] |
| Other | [96] |

[Page Break]

[Q1.4f] Why is this the credit card you use most often when making purchases?

Please select all that apply

| | |
|---|---|
| Card offers better rewards/points | [01] |
| Card has lower interest rates | [02] |
| Card offers discounts/coupons/promotions | [03] |
| I use the card to keep it activated | [04] |
| It is the only payment method they take/wouldn't take preferred | [05] |
| method | |
| I only use the credit card to make large/expensive purchases | [06] |
| Card has higher credit limits | [07] |
| Card is more convenient | [08] |
| I use card to keep track of spending/purchases | [09] |
| I use card to establish good credit/increase my credit rating or score | [10] |
| Fraud security concerns/Identity theft/financial info concerns | [11] |
| Rotate cards for different purchases/use different cards for different | [12] |
| things | |
| Other | [96] |
| Don't Know | [98] |

[Page Break]

[Q1.4g] Does this [PN: IF Q1.4A=1 INSERT “debit,” IF Q1.4A=2 INSERT “credit”] card have a rewards program?

Please select one

| | | |
|---|---|---|
| Yes | [1] | [Continue] |
| No | [2] | [Skip to Q1.5] |
| Don't Know | [8] | [Skip to Q1.5] |

### [Page Break]

[Q1.4h] How do you earn rewards with this [PN: IF Q1.4A=1 INSERT “debit,” IF Q1.4A=2 INSERT “credit”] card?

Please select one

| | | |
|---|---|---|
| Points | [1] | [Continue] |
| Miles | [2] | [Skip to Q1.4k] |
| Cash Back | [3] | [Skip to Q1.4l] |
| Don't | [8] | [Skip to Q1.5] |
| Know | | |

### [Page Break]

[Q1.4i] How many points do you earn for every dollar spent for this rewards program?

Please select one

| | | |
|---|---|---|
| ¼ | Point | [1] |
| ½ | Point | [2] |
| 1 | Point | [3] |
| 2 | Points | [4] |

| | |
|---|---|
| Other | [6] |
| Don't | [8] |
| Know | |

### [Page Break]

[Q1.4j] Considering typical bonus point earning opportunities (e.g., special earning categories such as gas), how many bonus points do you earn for every dollar spent?

| | | |
|---|---|---|
| 1 Bonus Point | [1] | [Skip to Q1.5] |
| 2 Bonus Points | [2] | [Skip to Q1.5] |
| 3 Bonus Points | [3] | [Skip to Q1.5] |
| 4 Bonus Points | [4] | [Skip to Q1.5] |
| Other | [6] | [Skip to Q1.5] |
| Don't Know | [8] | [Skip to Q1.5] |

### [Page Break]

[Q1.4k] How many miles do you earn for every dollar spent for this rewards program?

Please select one

| | | |
|---|---|---|
| 1 Mile | [1] | [Skip to Q1.5] |
| 2 Miles | [2] | [Skip to Q1.5] |
| Other | [6] | [Skip to Q1.5] |
| Don't Know | [8] | [Skip to Q1.5] |

### [Page Break]

[Q1.4l] What percentage of cash back do you earn for every dollar spent for this rewards program?

Please select one

| | |
|---|---|
| 0.25% | [1] |
| 0.50% | [2] |
| 1% | [3] |
| 2% | [4] |
| 5% | [5] |
| Other | [6] |
| Don't Know | [8] |

[Page Break]

[PN: Transition Statement] The next questions are about your experience with credit card rewards programs.

[Q1.5] Using a scale of 1 to 5, where 5 means “describes my opinion perfectly” and 1 means “does not describe my opinion at all,” which of the following best describes your general opinion of credit card rewards programs?

| Does Not | | | | Describes My |
|---|---|---|---|---|
| Describe My | | | | Opinion |
| Opinion at All | | | | Perfectly |
| [1] | [2] | [3] | [4] | [5] |

### [PN: ROTATE]

[a] Rewards programs are essential for me to do business with a company
[b] Rewards programs make me more loyal to certain companies
[c] I enjoy the benefits of the rewards programs, but the program does not affect my loyalty
[d] Rewards programs are a waste of time

### [Page Break]

[Q1.6] When you are deciding which credit card to use for purchases, to what extent does a credit card rewards program influence your decision?

| Does Not | | | | Is Primary |
|---|---|---|---|---|
| Influence | Influences | Influences | Influences | Reason for |
| At All | A Little | Somewhat | A Lot | Choice |
| [1] | [2] | [3] | [4] | [5] |

### [Page Break]

[Q1.7] How recently have you redeemed points from a credit card rewards program?

Please select one

| | | |
|---|---|---|
| Less than 1 month | [1] | [Continue] |
| 1 month to less than 6 months | [2] | [Continue] |
| 6 months to less than 12 months | [3] | [Continue] |
| More than 12 months | [4] | [Continue] |
| Never | [5] | [Skip to Q1.8] |

### [Page Break]

[Q1.7.a] What did you choose as your reward when you redeemed points [INSERT ANSWER FROM Q1.7] ago? Please be specific. (For example: a Music Player 30 GB, a Digital Camera, or a Department Store gift card.)

[Text field, 500 characters. Coding required]

### [Page Break]

[Q1.8] Have you recommended a credit card rewards program to your friends or family members in the last 6 months?

Please select one

| | | |
|---|---|---|
| Yes | [1] | [Continue] |
| No | [2] | [Skip to Q2.1] |
| Don't | [8] | [Skip to Q2.1] |
| Know | | |

### [Page Break]

[Q1.8a] What about the credit card rewards program made you want to recommend it?

Please be as specific as possible.

[PN: Open Text Box]

### [Page Break]

### [MODULE 2—Attitudinal]

[Q2.1] Using a scale from 1 to 5, where 1 means “Strongly Disagree” and 5 means “Strongly Agree,” please rate your level of agreement with the following statements about credit card rewards programs.

Select one answer per statement

| Strongly | Somewhat | Neither Agree | Somewhat | Strongly |
|---|---|---|---|---|
| Disagree | Disagree | Nor Disagree | Agree | Agree |
| [1] | [2] | [3] | [4] | [5] |

### [PN: ROWS; RANDOMIZE. REPEAT SCALE MID-WAY THROUGH THE LIST]

[a] I am knowledgeable about the rewards program(s) I am enrolled in
[b] I am knowledgeable about financial and credit issues
[c] Friends or family influenced my decision to choose a credit card rewards program
[d] I typically save points for a specific reward
[e] I have a preferred rewards currency (points, miles, cash, etc.)
[f] Company name and reputation impact my selection of a rewards program
[g] I feel that the rewards program is a part of my relationship with the company
[h] Rewards programs provide additional value to me
[i] Rewards programs have special offers that are relevant to me
[j] Rewards programs are flexible enough to meet my needs
[k] I am usually very loyal to my credit card company
[l] The communications from my credit card rewards programs are relevant
[m] Rewards programs do a very good job of communicating with me
[n] It is easy to order a reward from the programs in which I participate
[o] Credit card companies make it easy to redeem my points
[p] I always compare rewards pricing to actual retail price
[q] Rewards are my splurge products
[r] Rewards are my supplementary income
[s] I prefer to wait until “cool” rewards are available before redeeming points
[t] I hold my points until unique rewards are available for redemption
[u] I choose items from a wide variety of rewards categories
[v] The rewards program offers special services (such as a concierge service)
[w] The rewards program allows me to make choices that show a concern for the environment
[x] In most rewards programs, it is easy to earn enough points to obtain a reward
[y] It is important to me that I have the most current merchandise models
[z] Rewards programs should offer seasonal promotions

### [Page Break]

[Q2.1.a] In order to confirm your place in this survey, please select “Somewhat Agree” on the scale below.

| Strongly | Somewhat | Neither Agree | Somewhat | Strongly |
|---|---|---|---|---|
| Disagree | Disagree | Nor Disagree | Agree | Agree |
| [1] | [2] | [3] | [4] | [5] |

### [Page Break]

### [MODULE 3—Earn]

[Q3.1] What features and benefits of a credit card rewards program do you find MOST and LEAST valuable? Please read through the entire list, then mark one choice in each column.

[PN: COLUMNS-SELECT ONE ROW PER COLUMN. Require ONE response per column.]

5-MOST Valuable (check) [CODE=‘5’]

1-LEAST Valuable (check) [CODE=‘1’]

[ROWS; RANDOMIZE]

| | |
|---|---|
| Most | Least |
| Valua- | Valua- |
| ble | ble |

| | |
|---|---|
| [a] | Bonus points for every $100 spent |
| [b] | Bonus points for purchases at select merchants |
| [c] | Discounts on selected purchases |
| [d] | Accelerated point earning opportunities |
| | at specified ‘points earned’ levels |
| [e] | Added benefits or special services at specified |
| | ‘points earned’ levels |
| [f] | Special benefits or upgrades, e.g., free upgrades |
| | to first-class on airlines, preferred customer |
| | advantages for auto rentals |
| [g] | Earning points for suggesting ideas to your credit |
| | card issuer for improving the rewards |
| | program and its services |
| [h] | Bonus points at specified ‘points earned’ levels |
| [i] | Special point of sale/purchase offers |
| | customized for me |
| [j] | Bonus points for redeeming promotional |
| | merchandise |
| [k] | Earning points for visiting the rewards |
| | program website |

### [Page Break]

[Q3.2] Now, from the following list, please indicate which two features and benefits of a credit card rewards program you find MOST and LEAST valuable. Please read through the entire list, then mark two choices in each column.

[Programmer Note: Do not present items selected in Q3.1. Use multiple select check boxes. Require TWO responses per column. List should remain in same order as in Q3.1.]

### [Page Break]

[Q3.3] Are you currently saving up points for any program with a specific reward in mind?

Please select one

| | | |
|---|---|---|
| Yes | [1] | [Continue] |
| No | [2] | [Skip to Q4.1] |
| Don't Know | [8] | [Skip to Q4.1] |

### [Page Break]

[Q3.3a] What reward do you have in mind? (For example: a Music Player 30 GB, a Digital Camera, or a Department Store gift card.)

[TEXT FIELD 500 CHARACTER, CODING REQUIRED]

### [Page Break]

[MODULE 4—Burn]

[PN: Transition Statement] In this section of the survey, we would like your help in identifying the types of rewards that you would most prefer.

[PN: Rotate respondents across the three price point categories: 100, 200, and 400. This assignment will be applied for the entire section. Lists for question 4.1 will be selected by price point. The items selected in 4.1 will be used as four of the options in question 4.2.]

[Q4.1.a] If you had to choose from the following 3 rewards, which would you be most likely to choose?

[PN: Rotate rewards. Display image with each reward description.]

| | | |
|---|---|---|
| Music Player 1 GB | [01] | [Display if assigned to 100 price-point |
| | | category] |
| Stereo Speaker System | [02] | [Display if assigned to 100 price-point |
| with Music Player Dock | | category] |
| 900 MHz Wireless | [03] | [Display if assigned to 100 price-point |
| Headphone | | category] |
| Music Player 4 GB | [04] | [Display if assigned to 200 price-point |
| Video | | category] |
| 8.5″ Widescreen Portable | [05] | [Display if assigned to 200 price-point |
| DVD Player | | category] |
| Digital Zoom Camera | [06] | [Display if assigned to 200 price-point |
| | | category] |
| Camcorder | [07] | [Display if assigned to 400 price-point |
| | | category] |
| Music Player 8 GB | [08] | [Display if assigned to 400 price-point |
| | | category] |
| Center/Surround | [09] | [Display if assigned to 400 price-point |
| Speaker System | | category] |

### [Page Break]

[Q4.1.b] If you had to choose from the following 3 rewards, which would you be most likely to choose?

[PN: Rotate rewards. Display image with each reward description.]

| | | |
|---|---|---|
| 10-Pc. Cookware Set | [10] | [Display if assigned to 100 price-point |
| | | category] |
| Blender/Food Processor | [11] | [Display if assigned to 100 price-point |
| | | category] |
| 14-Pc. Cutlery Set | [12] | [Display if assigned to 100 price-point |
| | | category] |
| Thermal 10-Cup | [13] | [Display if assigned to 200 price-point |
| Coffeemaker | | category] |
| Commercial Garment | [14] | [Display if assigned to 200 price-point |
| Steamer | | category] |
| Professional Buffet | [15] | [Display if assigned to 200 price-point |
| Server and Warming | | category] |
| Tray | | |
| Stand Mixer | [16] | [Display if assigned to 400 price-point |
| | | category] |
| Propane Fireplace | [17] | [Display if assigned to 400 price-point |
| | | category] |
| Vacuuming Robot | [18] | [Display if assigned to 400 price-point |
| | | category] |

### [Page Break]

[Q4.1.c] If you had to choose from the following 3 rewards, which would you be most likely to choose?

[PN: Rotate rewards. Display image with each reward description.]

| | | |
|---|---|---|
| Premium Bag Triple | [19] | [Display if assigned to 100 price-point |
| Play Duffle | | category] |
| Computer Case | [20] | [Display if assigned to 100 price-point |
| | | category] |
| Premium Bag | [21] | [Display if assigned to 100 price-point |
| Expandable 2-Pc. | | category] |
| Luggage Set | | |
| 4P Luggage Set | [22] | [Display if assigned to 200 price-point |
| | | category] |
| 21″ Expandable | [23] | [Display if assigned to 200 price-point |
| Spinner | | category] |
| Rolling Garment Bag | [24] | [Display if assigned to 200 price-point |
| | | category] |
| 5 Pc. Luggage Set | [25] | [Display if assigned to 400 price-point |
| | | category] |
| 22″ Carry-On | [26] | [Display if assigned to 400 price-point |
| | | category] |
| Garment Spinner | [27] | [Display if assigned to 400 price-point |
| | | category] |

### [Page Break]

[Q4.1.d] If you had to choose from the following 3 rewards, which would you be most likely to choose?

[PN: Rotate rewards. Display image with each reward description.]

| | | |
|---|---|---|
| $100 Online Store Gift Certificate | [28] | [Display if assigned to 100 price-point |
| | | category] |
| $100 Electronics Store Gift Card | [29] | [Display if assigned to 100 price-point |
| | | category] |
| $100 Home Improvement Store Gift Card | [30] | [Display if assigned to 100 price-point |
| | | category] |
| $200 Online Store Gift Certificate | [31] | [Display if assigned to 200 price-point |
| | | category] |
| $200 Electronics Store Card | [32] | [Display if assigned to 200 price-point |
| | | category] |
| $200 Home Improvement Gift Card | [33] | [Display if assigned to 200 price-point |
| | | category] |
| $400 Online Store Gift Certificate | [34] | [Display if assigned to 400 price-point |
| | | category] |
| $400 Electronics Store Gift Card | [35] | [Display if assigned to 400 price-point |
| | | category] |
| $400 Home Improvement Gift Card | [36] | [Display if assigned to 400 price-point |
| | | category] |

### [Page Break]

[Q4.2] This section of the survey will present a series of rewards choices. For each question in this section, you will be asked to choose one of six rewards, or to select no reward and keep your points. Please read the descriptions carefully; although some of the reward options may look similar, they vary within each question as well as from one question to the next.

[PN: ROTATE RESPONDENTS ACROSS FOUR BLOCKS. TWELVE SETS OF QUESTIONS WILL BE SHOWN TO EACH RESPONDENT. THERE ARE 12 TOTAL SETS OF QUESTIONS (3 PRICE POINTS TIMES 4 BLOCKS). SHOW ONE QUESTION FROM SELECTED SET PER SCREEN USING THE FORMAT IN THE EXAMPLE.]

[PN: Randomize row order; randomize within rows. For example, always keep Cash, Travel Voucher, and Gift Cards on same row but rotate order within that row. Maintain the same order for each respondent.]

Example Question: You have 15,000 points. Which of the following rewards would you select?

| | | |
|---|---|---|
| $100 Cash | $100 Travel Voucher | $100 Electronics Store Gift |
| [PN: Insert | [PN: Insert Image Here] | Card |
| Image Here] | 14,000 points | [PN: Insert Image Here] |
| 8,000 points | | 8,000 points |
| Music Player | 10-Pc. Cookware Set | Premium Bag Expandable 2- |
| 1 GB | [PN: Insert Image Here] | Pc. Luggage Set |
| [PN: Insert | 6,000 points | [PN: Insert Image Here] |
| Image Here] | | 12,000 points |
| 10,000 points | | |

None of these. Keep my 15,000 points for another reward.

[Q4.3] Many programs reward card owners with points that are stored in an account or on a debit card. You then have some flexibility as to how you would spend your points. Using a scale of 1 to 5, where 5 means “describes my opinion perfectly” and 1 means “does not describe my opinion at all,” which of the following best describes how you would want to spend your points?

I want . . .

| Does Not | | | | Describes My |
|---|---|---|---|---|
| Describe My | | | | Opinion |
| Opinion at All | | | | Perfectly |
| [1] | [2] | [3] | [4] | [5] |

### [PN: ROWS; RANDOMIZE. REPEAT SCALE MID-WAY THROUGH THE LIST]

[a] To pick out a reward upfront and have it sent to me when I've earned it because that would be easy and hassle free
[b] To pick out a reward upfront because I like to picture in my mind what I'm trying to earn
[c] To check out the deals and sales and get the most value for my earnings
[d] A wide range of choices across product types (i.e., electronics and home and jewelry and clothing)
[e] A wide range of brand/model choices within a specific product type
[f] To be able to give my earnings to a friend or family member
[g] To be able to give my earnings to charity
[h] To be able to spend my earnings on gifts for friends or family members
[i] To splurge on something frivolous-something I would feel guilty about spending money on otherwise
[j] To be prompted with things to spend my earnings on, and then have a one-click or one-stop, no-hassle purchase
[k] To save my earnings in case I need them for a spur-of-the-moment splurge or need
[l] To save my earnings for a specific item or experience
[m] To spend my reward earnings as I receive them
[n] To spend my earnings on something I can show to my friends or family
[o] To use my earnings on an ‘adventure’ or something exciting
[p] To use my earnings on something to help me relax or make my life easier
[q] To redeem reward points at the point of sale/purchase to offset the cost of my purchase
[r] Special point of sale/purchase offers customized for me

### [Page Break]

### [Module 5—Communication Preferences]

[Q5.1] Please read the list below and select the communication method you would most prefer for each.

| | Printed | | Program | Card | Text | |
|---|---|---|---|---|---|---|
| | Mailings | Emails | Website | Statements | Messaging | Telephone |
| Enrollment | [1] | [2] | [3] | [4] | [5] | [6] |
| Learn About Program | [1] | [2] | [3] | [4] | [5] | [6] |
| Benefits | | | | | | |
| Get Updates on | [1] | [2] | [3] | [4] | [5] | [6] |
| Reward Selections | | | | | | |
| Account Statement | [1] | [2] | [3] | [4] | [5] | [6] |
| Get Information on | [1] | [2] | [3] | [4] | [5] | [6] |
| Special Offers | | | | | | |

### [Page Break]

[Q5.1.2] When redeeming your points, do you prefer to have . . .

Please select one

| | | |
|---|---|---|
| Your points automatically redeemed for you | [1] | [Skip to Q5.1.4] |
| Your points accumulate until you redeem | [2] | [Continue] |
| them | | |

### [Page Break]

[Q5.1.3] How do you prefer to redeem your points?

Please select one

| | |
|---|---|
| Online | [1] |
| Telephone | [2] |

[Page Break]

[Q5.1.4] How do you prefer to browse the rewards catalog?

Please select one

| | |
|---|---|
| Online | [1] |
| Printed | [2] |
| Catalog | |

### [Page Break]

[Q5.2] Below are a list of topics that might be of interest to you as they relate to credit card rewards. Using a scale of 1 to 5, where 5 means “extremely interested” and 1 means “extremely uninterested,” please indicate how interested you are in each of the topics below.

| | | Extremely | | | | Extremely |
|---|---|---|---|---|---|---|
| | | Uninterested | | | | Interested |
| [a] | How the rewards program | [1] | [2] | [3] | [4] | [5] |
| | works | | | | | |
| [b] | How to make the most of a | [1] | [2] | [3] | [4] | [5] |
| | rewards program | | | | | |
| [c] | Website usage information | [1] | [2] | [3] | [4] | [5] |
| [d] | Rewards Program updates | [1] | [2] | [3] | [4] | [5] |
| | and changes | | | | | |
| [e] | Special offers | [1] | [2] | [3] | [4] | [5] |
| [f] | New Rewards Categories | [1] | [2] | [3] | [4] | [5] |

### [PN: Short Complete]

### [Module 6—Demographics]

[PN: Transition Statement] The following questions will be used for classification purposes only.

[Q6.1] Please enter your age in the space provided.

[PN: INCLUDE TEXT BOX; ACCEPT 18-99]

[PN: ADD A ‘PREFER NOT TO ANSWER’ OPTION]

### [Page Break]

[Q6.2] Which of the following best describes you?

Please select one

| | |
|---|---|
| White/Caucasian | [1] |
| Asian | [2] |
| African American | [3] |
| Indian | [4] |
| Other | [5] |

### [Page Break]

[Q6.3] Are you of Hispanic origin?

Please select one

| | |
|---|---|
| Yes | [1] |
| No | [2] |

### [Page Break]

[Q6.4] Which of the following best describes where you live?

Please select one

| | |
|---|---|
| City | [1] |
| Suburb | [2] |
| Town | [3] |
| Rural | [4] |
| Area | |

### [Page Break]

[Q6.5] How many children under the age of 18 currently reside in your household?

### [PN: INCLUDE TEXT BOX; ACCEPT 0 to 20]

### [Page Break]

[Q6.6] Which of the following best describes your education level?

Please select one

| | |
|---|---|
| Some high school or less | [1] |
| High school graduate | [2] |
| Some college | [3] |
| Vo-tech graduate | [4] |
| College graduate | [5] |
| Some post-graduate work | [6] |
| Post graduate (Masters or equivalent or above) | [7] |

### [Page Break]

[Q6.7] Please select the employment category that best describes you.

Please select one

| | |
|---|---|
| Proprietor/business owner | [01] |
| Executive level | [02] |
| Middle management | [03] |
| Professional | [04] |
| Skilled technician/Skilled trade | [05] |
| Police/Fireman | [06] |
| Sales | [07] |
| General labor force | [08] |
| Educator | [09] |
| Farmer | [10] |
| Artist | [11] |
| Homemaker | [12] |
| Student | [13] |
| Retired | [14] |
| Other | [96] |

### [Page Break]

[Q6.8] What is your annual household income before taxes?

Please select one

| | |
|---|---|
| Less than $30,000 | [1] |
| $30,000 to less than $45,000 | [2] |
| $45,000 to less than $60,000 | [3] |
| $60,000 to less than $80,000 | [4] |
| $80,000 to less than $100,000 | [5] |
| $100,000 to less than $125,000 | [6] |
| $125,000 or more | [7] |

### [Page Break]

[Q6.9] How many times per year do you travel for business?

Please select one

| | |
|---|---|
| Never | [1] |
| 1 to 5 times yearly | [2] |
| 6 to 10 times yearly | [3] |
| 10 to 20 times yearly | [4] |
| More than 20 times yearly | [5] |

### [Page Break]

[Q6.10] How many times per year do you travel for leisure?

Please select one

| | |
|---|---|
| Never | [1] |
| 1 to 2 times yearly | [2] |
| 3 to 5 times yearly | [3] |
| 6 to 8 times yearly | [4] |
| More than 8 times yearly | [5] |

### [Page Break]

Thank you your feedback. We appreciate your willingness to set time aside and participate in our survey.

What is claimed is:

1. A method of defining an earnings profile for loyalty reward program for a plurality of participants, said method comprising:
defining a plurality of loyalty reward program earning types;
defining a survey to gather data related to the defined loyalty reward program earning types of the plurality of participant;
collecting response data from the plurality of participants related to the presented survey, said response data including loyalty reward program earning type preferences;
identifying one or more segments of participants are identified as a function of the collected data wherein each identified segment of participants includes participants associated with the a subset of the loyalty reward program earning types and wherein each of the identified segment of participants includes a similar loyalty reward program earning type preferences;
analyzing the collected loyalty reward program earning type preferences to determine a reach, frequency, and overlap of the loyalty reward program earning types for the identified segment;
rendering a user interface indicating the determined reach, frequency, and overlap of the loyalty reward program earning types for the identified segments based on the analyzed loyalty reward program earning type preferences; and
selecting at least one of the defined loyalty reward program earning types based on the determined reach, frequency, and overlap of the loyalty reward program earning types for identified segments for the earnings profile of the loyalty reward program.

2. The method of claim 1, wherein the survey includes Q-sort formatted questions for gathering data related to the defined loyalty reward program earning types.

3. The method of claim 1, wherein cluster analysis is conducted on the collected loyalty reward program earning type preferences to identify the segments of participants.

4. The method of claim 1, wherein TURF (Total Unduplicated Reach & Frequency) analysis is conducted on the collected loyalty reward program earning type preferences to determine the reach, frequency, and overlap of the loyalty reward program earning types for the identified segments.

5. The method of claim 1, wherein the defined loyalty reward program earning types include one or more of the following: Bonus points for every $100 spent, bonus points for purchases at selected merchants; discounts on selected purchases, accelerated point earning opportunities at specified ‘points earned’ levels, added benefits or special services at specified ‘points earned’ levels, special benefits or upgrades, earning points for suggesting ideas to loyalty reward program owner, bonus points at specified ‘points earned’ levels, special point of sale/purchase offers customized for each of the plurality of participants, bonus points for redeeming promotional merchandise, earning points for visiting the rewards program website.

6. The method of claim 1, wherein the survey includes one or more of the following: loyalty reward program knowledge questions, loyalty reward program usage questions, loyalty reward program attitudinal questions, communication preference questions, and demographic questions.

7. The method of claim 1, further comprising:
offering the loyalty reward program including the earnings profile comprising the selected, defined loyalty reward program earning types to a plurality of customers.

8. A method of defining a reward profile for loyalty reward program for a plurality of participants, said method comprising:
defining a plurality of loyalty reward types of the loyalty reward program;
defining a survey to gather data related to the defined loyalty reward types of the plurality of participants;
collecting response data from the plurality of participants related to the presented survey, said response data including loyalty reward type preferences;
identifying one or more segments of participants as a function of the collected data wherein each identified segment of participants includes participants associated with the a subset of the loyalty reward types and wherein each identified segment of participants includes similar loyalty reward type preferences;
analyzing the collected loyalty reward type preferences to determine a preference share for each of the plurality of participants for each of the plurality of loyalty reward types;
rendering a user interface indicating a choice of loyalty reward type for the identified segments based on the determined preference shares of the participants within the segment; and
selecting at least one of the defined loyalty reward types based on the viewed determined choice for identified segments for the reward profile of the loyalty reward program.

9. The method of claim 8, wherein the survey includes Q-sort formatted questions for gathering data related to the defined loyalty reward types.

10. The method of claim 8, wherein cluster analysis is conducted on the collected loyalty reward type preferences to identify the segments of participants.

11. The method of claim 8, wherein the analyzing further comprises:
modeling the collected loyalty reward type preferences utilizing multinomial logit to produce utilities;
scaling the produced utilities to determined the preference shares of each of the plurality of participants.

12. The method of claim 8, wherein the defined loyalty reward types include one or more of the following: Electronics, house wares, luggage, travel, Gift Card, and cash.

13. The method of claim 8, wherein the survey includes one or more of the following: loyalty reward program knowledge questions, loyalty reward program usage questions, loyalty reward program attitudinal questions, communication preference questions, and demographic questions.

14. The method of claim 8, further comprising:
offering the loyalty reward program including the reward profile comprising the selected, defined loyalty reward types to a plurality of customers.

15. A method of defining an earnings profile and a reward profile for loyalty reward program for a credit card issuer for a plurality of participants, said method comprising:
defining a plurality of loyalty reward program earning types;
defining a plurality of loyalty reward types of the loyalty reward program;
defining a survey to gather data related to the defined loyalty reward program earning types and the defined loyalty reward types of the plurality of participants;
collecting response data from the plurality of participants related to the survey, said response data including loyalty reward program earning type preferences and loyalty reward type preferences;
identifying one or more segments of participants as a function of the collected data wherein each identified segment of participants includes participants associated with the a subset of the loyalty reward program earning types or a subset of the loyalty reward types, and wherein each identified segment of participants includes a similar loyalty reward program earning type preferences or wherein each identified segment of participants includes similar loyalty reward type preferences;
analyzing the collected loyalty reward program earning type preferences to determine a reach, frequency, and overlap of the loyalty reward program earning types for the identified segments;
analyzing the collected loyalty reward type preferences to determine a preference share for each of the plurality of participants for each of the plurality of loyalty reward types;
rendering a first user interface indicating the determined reach, frequency, and overlap of the loyalty reward program earning types for the identified segments based on the analyzed loyalty reward program earning type preferences;
rendering a second user interface indicating a choice of loyalty reward type for the identified segments based on the determined preference shares of the participants within the segment;
selecting at least one of the defined loyalty reward program earning types based on the determined reach, frequency, and overlap of the loyalty reward program earning types for identified segments for the earnings profile of the loyalty reward program; and
selecting at least one of the defined loyalty reward types based on the viewed determined choice for identified segments for the reward profile of the loyalty reward program.

16. The method of claim 15, wherein the survey includes Q-sort formatted questions for gathering data related to the defined loyalty reward program earning types.

17. The method of claim 15, wherein cluster analysis is conducted on the collected response data to identify the segments of participants.

18. The method of claim 1, wherein TURF (Total Unduplicated Reach & Frequency) analysis is conducted on the collected loyalty reward program earning type preferences to determine the reach, frequency, and overlap of the loyalty reward program earning types for the identified segments.

19. The method of claim 15, wherein the survey includes one or more of the following: loyalty reward program knowledge questions, loyalty reward program usage questions, loyalty reward program attitudinal questions, communication preference questions, and demographic questions.

20. The method of claim 15, wherein the analyzing the collected loyalty reward type preferences further comprises:
modeling the collected loyalty reward type preferences utilizing multinomial logit to produce utilities;
scaling the produced utilities to determine the preference shares of each of the plurality of participants.

21. A computerized system of defining an earnings profile and a reward profile for loyalty reward program for a credit card issuer for a plurality of participants, said system for use with:
a plurality of loyalty reward program earning types;
a plurality of loyalty reward types of the loyalty reward program;
a survey to gather data related to the defined loyalty reward program earning types and the defined loyalty reward types of the plurality of participants;
response data collected from the plurality of participants related to the survey, said response data including loyalty reward program earning type preferences and loyalty reward type preferences; said system comprising computer executable instructions stored on a computer readable media including:
instructions for identifying one or more segments of participants as a function of the collected data wherein each identified segment of participants includes participants associated with the a subset of the loyalty reward program earning types or a subset of the loyalty reward types, and wherein each identified segment of participants includes a similar loyalty reward program earning type preferences or wherein each identified segment of participants includes similar loyalty reward type preferences;
instructions for analyzing the collected loyalty reward program earning type preferences to determine the reach, frequency, and overlap of the loyalty reward program earning types for the identified segments;
instructions for analyzing the collected loyalty reward type preferences to determine the preference share for each of the plurality of participants for each of the plurality of loyalty reward types;
instructions for rendering a first user interface indicating the reach, frequency, and overlap of the loyalty reward program earning types for the identified segments based on the analyzed loyalty reward program earning type preferences;
instructions for rendering a second user interface indicating the choice of loyalty reward type for the identified segments based on the determined preference shares of the participants within the segment;
instructions for selecting at least one loyalty reward program earning type based on the viewed reach, frequency, and overlap of the loyalty reward program earning types for identified segments for the earnings profile of the loyalty reward program; and
instructions for selecting at least one loyalty reward type based on the viewed determined choice for identified segments for the reward profile of the loyalty reward program.

22. The system of claim 21, further comprising:
instructions for offering the loyalty reward program including the loyalty reward program including the reward profile comprising the selected, defined loyalty reward types to a plurality of customers and the earnings profile comprising the selected, defined loyalty reward program earning types to a plurality of customers.
